(19) United States
(12) Patent Application Publication
(10) Pub. No.: US 2007/0005412 A1
(43) Pub. Date: Jan. 4, 2007

(54) Electronic requirement management system with checklists on a handheld computer

(76) Inventors: David Frederick Martinez, Cypress, TX (US); Charles Christian Birkner, Magnolia, TX (US); Elias George ElDahdah, Humble, TX (US)

Correspondence Address: TRAN & ASSOCIATES, 6768 MEADOW VISTA CT., SAN JOSE, CA, 95135, US

(21) Appl. No.: 11/173,796

(22) Filed: Jul. 2, 2005

(51) Int. Cl. G06F 9/46

(52) U.S. Cl. 705/8

(57) ABSTRACT

A construction management system includes a handheld computer adapted to collect construction data from the field and to automatically provide a checklist; a planning system to track budgetary information; a design system to perform site engineering assessment; and a construction system to track material consumption and progress for each project, the construction system adapted to receive data collected from the handheld computer.

### BACKGROUND

This application is related to application Ser. No. 09/814,250, filed on Mar. 21, 2001, the content of which is incorporated by reference.

The present invention relates to a computerized laboratory information management system.

As modern commerce depends on reliable and cost-effective methods for delivering products from suppliers to users, the availability of durable and reliable highways, roads and other support surfaces for vehicles is vital for sustaining a modern economy. To provide better support surfaces, highways, roads, and sidewalks are frequently paved with a layer or mat of asphalt concrete that is laid over the surface of the sub-base.

The non-concrete Construction Materials needs to be tested. The testing of construction materials is performed as a quality control and quality acceptance function (a quality assurance program) to test materials and workmanship quality. Typically, laboratory testing is performed for materials and in-place inspection is performed for workmanship. Laboratory testing of material quality directly measures the conformance with material specifications.

To ensure that the materials conform to the specification, various tests have been developed for standard test methods for Quality Assurance/Quality Control of soils, aggregates, asphalt, cement asphalt and concrete mixes. The testing technology is rapidly changing due to increasing demands in the material laboratory to provide new levels of service. These new levels of service must be more cost effective to decrease the operating expenditures such as labor cost and the like, and must provide shorter turnaround time of test results as well as improve the accuracy of the analysis. Modernization of analytical apparatus and procedure demands consolidation of workstations to meet the growing challenge placed on the material testing laboratories.

Many construction projects are performed today with contracts that include design build and design bid build and some design bid build, design build, and some contracts have performance-based specification as part of payment incentives. Tracking quality control and acceptance results on a real-time basis allows contractors to keep material processes within specifications to maximize bonus payments as part the contract payment incentives. Also, real-time quality control tracking allows the contractors for avoid penalties for putting non-conforming material in-place. This reduces the amount of removal of non-conformance materials or minimized the payment penalties for materials outside of specifications.

### SUMMARY

A construction management system includes a handheld computer adapted to collect construction data from the field and to check field work with a checklist using a handheld computer. Construction items method specifications outline workmanship and testing requirements. The use of predetermined checklist facilitates and provides consistency to the workmanship inspection and audit activities. The use of the handheld computer with predetermined sampling and testing reports simplifies and improves the accuracy and efficiently of material testing activities. The checklist operations include selecting an item to be checked from a menu of construction items and formulating into required questions and providing electronic checklists; entering one or more key fields for Item and inspector name; locating information for certain fields based on key fields and automatically filling the fields; displaying a sequence of questions and collecting answers relating to a checklist for the item; capturing a signature from an inspector; and uploading the checklist information to a server;

The system can include a planning system to track budgetary information; a design system to perform site engineering assessment; and a construction system to track material consumption and progress for each project, the construction system adapted to receive data collected from the handheld computer.

Implementations of the system may include one or more of the following. The handheld computer collects work in progress data such as project and contract identification, inspector identification, item number, location, and one or more description of activities. The the handheld computer collects labor related information such as labor type, quantity and hours. The handheld computer also collects equipment information such as equipment type, quantity, hours in use and stand-by hours. The handheld computer can also collect submittal information such as weather condition, comments, and an inspector name. The handheld computer sends collected information to a server. The collected information may be sent wirelessly using a wireless handheld unit. Alternatively, a modem coupled to the handheld computer can be used to transmit the information. Also, a hot-sync cradle coupleable to the handheld computer can be used for hot-syncing the collected information for transmission to a server.

Advantages of the system may include one or more of the following. The system manages the construction of multiple projects using inexpensive handheld computers communicating with a server. The handheld computer stores daily field journals such as work progress of unit bid items and contract deliverables, manpower utilization, equipment utilization, and general information including weather, temperature, remarks, and the inspector's name. The handheld computer also captures an inspection checklist and generates Punch list items, tracks Punch list items, takes facility inventory, and tracks facility repairs and cost estimates. The handheld also handles project documentation, such as project specifications, industry specifications, and drawing logs, among others.

The system is an integrated program management system where the processes for planning process, designing and constructing operations share the same information. The system can also perform program management where a large construction program can have a plurality of projects within that program. The system can manage the process of planning long range budget plans and after the plans have been approved, the system can specify for a particular year the projects that are in a design phase where an architect or engineering firm performs initial site feasibility studies, performs the design work so that the project can receive bids from construction companies. The system can also provide project tracking on a day to day basis. The tracking can be done using an inspection system field notebook system that tracks the progress of the project on a day to day basis as well as values that are paid to the contractor so that correct intermediate progress payments can be made for a particular project.

The system is as easy to use as the pen and paper approach and provides information integration advantages, including the ability to capture data from scanners, barcode readers, or the Internet. Furthermore, as portable computers are typically deployed in field applications by service providers where employees are scattered over a wide geographic area, the information advantages arising from integrating data collected from handheld computers include an ability to link information generated at the client's site with follow-up discussions and letters necessary to close the transaction enhances the efficiency of field personnel. The handheld computer is small and inexpensive. Thus, field personnel can perform data collection without carrying a relatively bulky laptop or notebook computer.

Other advantages of the invention may include one or more of the following. The system provides an efficient, integrated system for keeping track of job details that are constantly changing. The management of proposal submittals becomes convenient. Further, the tracking submittal responses or approvals are streamlined. The submittals, transmittals, change orders, request for information, meeting minutes, daily reports, activity logs, and other job related documents are organized and instantly searchable. The system enables information related to a building production to be managed unitarily by making use of a computer and to properly transmit production information generated at each stage of the production to the next process. The field-based project managers can be constantly in touch with the main office via phone, fax, or courier to ensure that their job information is accurate and up-to-date. Production and cost information from the system can be sent directly to the accounting staff for entry into the job costing and accounting software. Further, the system avoids requiring duplicate entries to be made.

In another aspect, a computer-implemented method to perform analysis on a construction materials mixtures and individual components includes accessing a server located on a wide-area-network; sending information collected from the material mixture to the server; applying one or more test methodologies to the collected information; generating one or more reports from the test methodologies; and sending the one or more reports to a project manager. Implementations of this aspect may include one or more of the following. The method can provide an Internet browser interface to access the server located on the wide-area-network. The computer-implemented method can apply in general to asphalt concrete, concrete and soils aggregate test and inspection methodologies. The aggregate test methodologies can include any testing methodologies with one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

Advantages of the system may include one or more of the following. The system allows a user to analyze material testing data from beginning to end using one centralized resource. This makes the material testing process easier to understand for the user and allows the user to control and monitor progress relating to the analysis of the materials.

The system completes a material analysis transaction with many users, keeping track of what each user is doing and progress. The system allows the entire process to be accessible from one central location on a network. The system is also efficient and low in operating cost. It also is highly responsive to user requests.

Other advantages and features will become apparent from the following description, including the drawings and claims.

### BRIEF DESCRIPTION OF THE DRAWINGS

FIG. 1 shows an environment for processing material test quality control or quality assurance transactions.

FIG. 2 shows one embodiment of a process for processing material test information.

FIGS. 3A-3E show an exemplary process and various exemplary user interfaces for performing gyratory compaction.

FIGS. 4A-4F show an exemplary process and various exemplary user interfaces for performing ignition tests on materials.

FIGS. 5 shows an exemplary process in providing a checklist for work completed in the field.

FIGS. 6-22 are exemplary user interfaces on the handheld computer in collecting data in the field.

### DESCRIPTION

Referring now to the drawings in greater detail, there is illustrated therein structure diagrams for a laboratory information management system and logic flow diagrams for the processes a computer system will utilize to complete various material tests. It will be understood that the program is run on a computer that is capable of communication with consumers via a network, as will be more readily understood from a study of the diagrams.

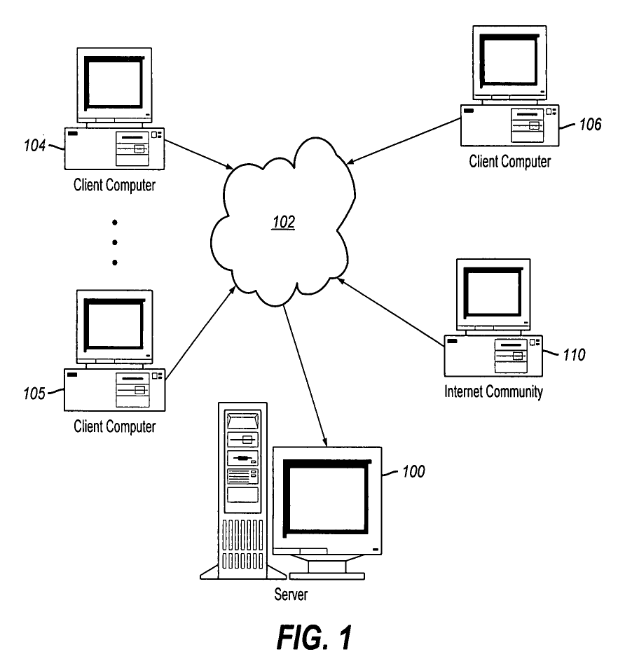

FIG. 1 shows an environment for processing a laboratory material analysis. A server 100 is connected to a network 102 such as the Internet. One or more client workstations 104-106 are also connected to the network 102. The client workstations 104-106 can be personal computers or workstations running browsers such as Netscape or Internet Explorer. With the browser, a client or user can access the server 100's Web site by clicking in the browser's Address box, and typing the address (for example, www.atser.com), then press Enter. When the page has finished loading, the status bar at the bottom of the window is updated. The browser also provides various buttons that allow the client or user to traverse the Internet or to perform other browsing functions.

An Internet community 110 with one or more building construction companies, service providers, manufacturers, or marketers is connected to the network 102 and can communicate directly with users of the client workstations 104-106 or indirectly through the server 100. The Internet community 110 provides the client workstations 104-106 with access to a network of test service providers.

Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 100 allows a consumer to log onto a computerized laboratory analysis software package incorporating AASHTO,ASTM or a state agency version of standard test methods for Quality Assurance/Quality Control of soils, aggregates, asphalt, cement asphalt and concrete mixes. Information relating to the various portions of a transaction are captured and stored in a single convenient location where it can be accessed at any time.

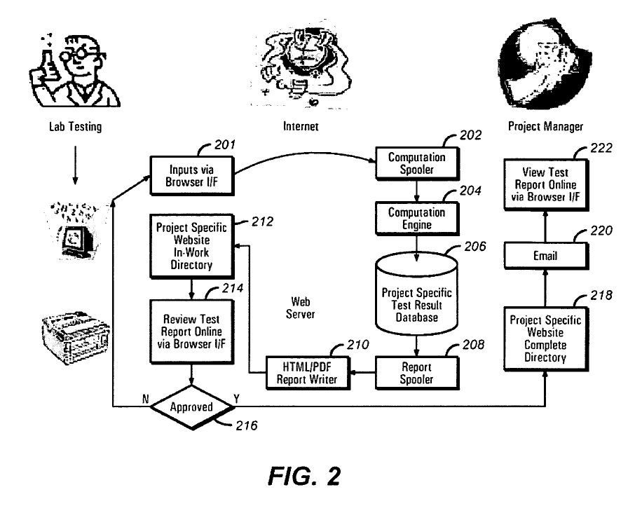

FIG. 2 shows an exemplary process 200 for providing a network-based Laboratory Information Management System (LIMS) on the server 100. First, browser based user interfaces are used to collect test result inputs (step 201). These inputs are collected by the server 100 and provided to a computation spooler (step 202). The spooler activates a computation engine performing the appropriate engineering calculation (step 204) and writes this information to a project specific test result database (step 206). The process 200 then activates a report spooler (step 208). The report spooler then sends output information to a report writer that stores this information in an In-Work directory for each project for review by a lab manager (step 210). In one embodiment, the report writer can generate HTML or PDF documents for viewing.

The lab manager classifies the test results (step 212). Unapproved test results will require updates to the test inputs, recalculation of results, and re-posting of the information to the In-Work website directory. Approved test reports will be promoted to the completed directory on a project specific website. The project specific website directories provide for data security and separation of client's project specific information. The process 200 sends an email notification to a Project Manager for viewing of the final report online (step 214).

The computer-implemented method can apply one or more test methodologies, for example aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

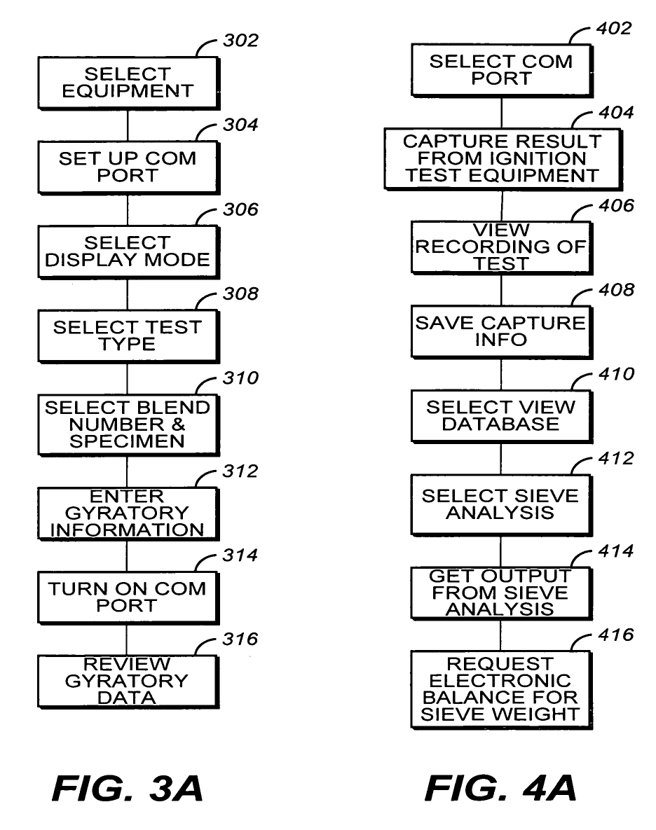

By supporting a plurality of test methodologies, the process of FIG. 3 offers a comprehensive laboratory analysis incorporating AASHTO and ASTM standard test methods for Quality Assurance/Quality Control of soils, aggregates, asphalt, cement asphalt and concrete mixes.

The computer-implemented method can apply aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

In one implementation, the following aggregate calculations are done. The Los Angeles Abrasion method covers the procedure for testing coarse aggregate for resistance to degradation using the Los Angeles testing machine, as defined in AASHTO T96, ASTM C131. The soundness test measures aggregate resistance to disintegration according to AASHTO T104. The 24 Hour Water Absorption test method covers the determination of specific gravity and absorption of coarse aggregate pursuant to AASHTO T85-91, ASTM C127-88. The sand equivalent serves as a rapid field test to show the relative proportion of fine dust or claylike material in soils or graded aggregates. The Unit Weight and Voids in Aggregate test method covers the determination of unit weight in a compacted or loose condition and calculated and in fine, coarse, or mixed aggregates based on the determination under ASTM C29, AASHTO T19. The specific gravity, water absorption and moisture method is used to determine the bulk specific gravity and water absorption of aggregate retained on a No. 80 sieve, as defined in ASTM T84. The clay lumps and friable particles in aggregate method covers the approximate determination in clay lumps and friable particles in natural aggregates, per AASHTO T112-91. The sieve analysis method is used to determine the particle size distribution of aggregate samples, using sieves with square openings under ASTM C136, ASSHTO T27

For soils, the Soil Liquid, Plastic Limit and Plasticity Index procedure determines the liquid limit of soils, defined as the water content of a soil at the arbitrarily determined boundary between the liquid and plastic states, expressed as a percentage of the oven-dried mass of the soil. It also determines the plastic limit and plasticity index in soil as defined in ASSHTO T89,90,91. The Material in Soil Finer then # 200 Sieve method determines the amount of soil material finer than the 75 μm (No. 200) sieve under AASHTO T11, ASTM D1140. The Moisture and Density of Soil-Aggregate In-Place by nuclear method covers the determination of the total or wet density of soil and soil aggregate in-place by the attenuation of gamma rays. The Moisture Content method covers the laboratory determination of the moisture content of soil under AASHTO T265. The specific gravity of soils method covers the determination of the specific gravity of soils by means of a pycnometer under AASHTO T100-95, ASTM D854-83 The Unconfined Compressive Strength of Cohesive Soil method covers the determination of the unconfined compressive strength of cohesive soil in the undisturbed, remolded, or compacted condition as discussed in AASHTO T208-96, ASTM D2166-85. The sieve analysis of fine and coarse aggregates method covers the determination of the particle size distribution of fine and coarse aggregate by sieving, as discussed in AASHTO T27-97, ASTM C136-95A. The compaction test is intended for determining the relation ship between the moisture content and density when compacted under ASSHTO T99,T180, ASTM D698,D1557. The California Bearing Ratio (CBR) method covers the determination of the (CBR) of pavement subgrade, subbase, and base/course material from laboratory compacted specimens under AASHTO T193-98. The density and unit weight of soil in place by the sand-cone method may be used to determine the in-place density and unit weight of soils using a sand cone apparatus as discussed in ASTM D1556.

For asphalts, the extraction method covers the recovery by the Abson method of asphalt from a solution from a previously conducted extraction (ASTM D1856, ASHTO T170). The emulsion test is described under the headings titled Composition, Consistency, Stability, and examination of residue of ASTM 244, ASSTO T59.

For asphalt mix, the ignition test method covers the determination of asphalt content of hot-mix asphalt (HMA) paving mixtures and paving samples by removing the asphalt content at 540 C by ignition in a furnace, per ASTM D6307-98. The actual specific gravity (BSG, Gsb) test method covers the determination of bulk specific gravity of specimens of compacted bituminous mixtures, per AASHTO T166. The theoretical maximum (Rice, or Gmm) specific gravity test method covers the determination of the theoretical maximum specific gravity and density of uncompacted bituminous paving mixtures at 25 C pursuant to AASHTO T209. The tensile strength ratio method covers preparation of the specimens and measurement of the change of diametral tensile strength, per AASHTO T283-89. The Marshall stability test method covers the measurement of the resistance to plastic flow of cylindrical specimens of bituminous paving mixture loaded on the lateral surface by means of Marshall apparatus, per ASTM D1559-89. The Hveem Stability test methods cover the determination of (1) the resistance to deformation of compacted bituminous mixtures by measuring the lateral pressure developed when applying a vertical load by means of Hveem stabilometer, and (2) the cohesion of compacted bituminous mixtures by measuring the force required to break or bend the sample as a cantilever beam by means of the Hveem cohesiometer, per ASTM D1560-92. The voids calculation method covers determination of the percent air voids in compacted dense and open bituminous paving mixtures, as described in AASHTO T269.

The concrete mix test includes the Unit Weight, Yield, and Air Content of Concrete Mix test method that covers determining the weight per cubic meter (cubic yard) of freshly mixed concrete and gives formulas for calculating yield, cement content, and air content of the concrete. Except for editorial differences, this procedure is the same as ASTM C 138 and AASHTO T 121. The Quality of Water to be used in Concrete test method tests for acidity or alkalinity, per AASHTO T26-79. The Compressive Strength of Cylinder Concrete Specimens method covers determining compressive strength of cylindrical concrete specimens such as molded cylinders and drilled cores. . The flexural strength of concrete test method covers the determination of flexural strength of concrete by the use of a simple beam with third-point loading, per AASHTO T97-86, and ASTM C78-84. The air content method determines the air content of freshly-mixed concrete by observation of the change in volume of concrete with a change in pressure, as described in AASHTO T152-97 and ASTM C231-91B.

The process of FIG. 2 also includes full automatic report generation capability with forms stored within the system. Graphing capabilities include Proctor, PI test, Control Chart, statistical and standard deviation analysis and others. The software can statistically compare test results. Statistical comparisons are performed by over-plotting the contractors' quality control test results and the owners' quality acceptance results. Statistical test are then performed to evaluate the mean, standard deviation, sample size, test frequencies, cumulative frequencies, percent within-limit, percent out-of-limit, F-test (variability testing), T-test (means testing). These statistical tests are important for contractors and owners to determine pay factor adjustments and to assess the level of owners risk in material acceptance.

As part of the quality control, gyratory compaction tests may be performed. Since the 1930's, gyratory compaction has been used in asphalt mixture design under a procedure developed by the Texas Department of Transportation. The number of gyrations are expected to simulate pavement density at the end of life. The original gyrator compaction procedure was done manually. In the late 1950's-early 1960's, mechanized compactors were developed. These gyrators typically applied gyrations continuously while holding vertical pressure constant. In certain models, gyrations continue until the ratio of height change per revolution decreases below a predetermined limit. Other criteria for applying the gyrations include maintaining a constant angle during compaction, a constant vertical pressure, and a constant rate of gyration.

FIGS. 3A-3E show a process 300 and various user interfaces for performing gyratory compaction. First, the user selects a gyratory equipment type (step 302). The equipment can be a unit commercially available from a variety of vendors, including Test Quip, Inc. of New Brighton, Minn.; Rainhart Company of Austin, Tex.; Pine Instrument Company of Grove City, Pa.; and Troxler Electronic Laboratories, Inc. of Research Triangle Park, N.C. Next, the user sets up communications port with the equipment selected in step 302 (step 304). The user selects a display mode: Real Time or Import from a file (step 306). The user then selects a test type, in this embodiment a Trial Blend type or Design Binder Content type (step 308). Additionally, the user selects a blend number and specimen number (step 310). When the user is ready to run a test, the user clicks on an “Info” button to enter the information on the gyratory session (step 312). This information can also be entered after a test. The user then turns on the communication port (step 314), and review and check data generated by the gyratory equipment (step 316).

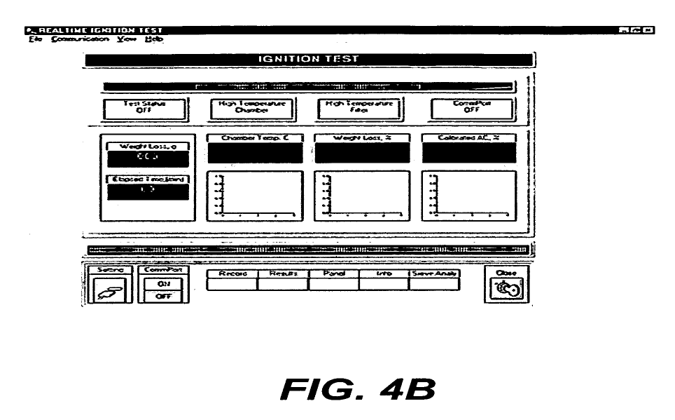

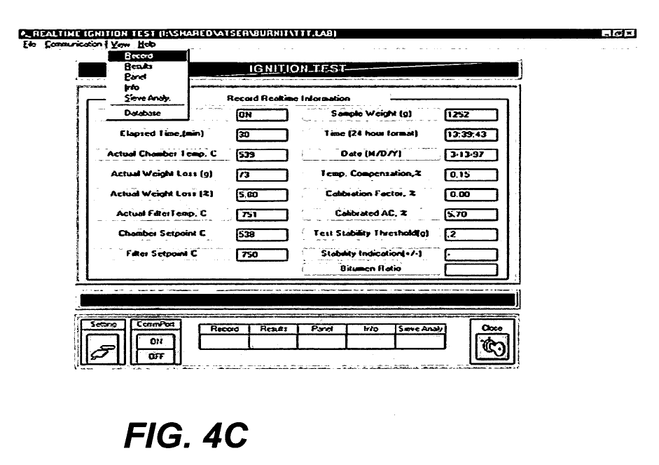

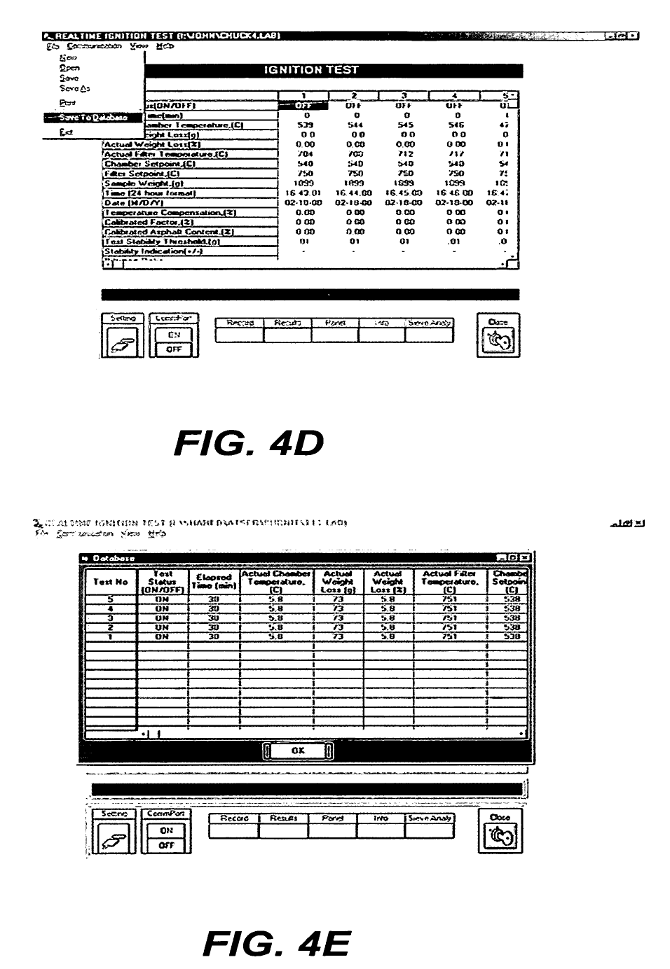

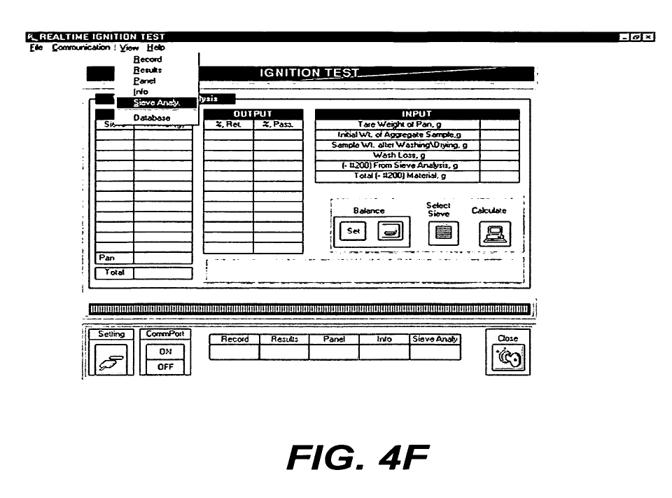

FIGS. 4A-4F show a process 400 and various user interfaces for performing ignition tests on materials. The process 400 supports a communication link between ignition furnaces to record chamber temperature, % weight loss, and calibrated % AC in a real-time tracking mode. In one exemplary implementation, an exemplary user interface is shown in FIG. 4A with a plurality of panel buttons which are also accessible from a menu bar under View. First, the user selects and turns on a particular communication port (step 402). Next, the user can capture the test results from a particular ignition test equipment through the selected port (step 404). In the embodiment of FIG. 4A, clicking on a “RECORD” button allows the user to see the test in real time. The user can also view a by-the-minute recording of the test after it is complete (step 406). In the embodiment of FIG. 4A, this can be done using a “RESULT” button. After completion, the user can save the captured information (step 408). In the embodiment of FIG. 4A, the user can select FILE and the Save from the menu bar to save the test results, first as a sequential file, and then select “Save to Database” to add it to an ignition database. The user can also print results to the printer. Next, the user can select View Database to view the Test results database of all tests completed (step 410). The tests are shown in order from last completed in one embodiment.

The user can also select a “Sieve Analysis” option, which allows the user to input sieve data and track results easily (step 412). After inputting results, the user can select “Calculate” to get output (step 414). The user can also specify a “Balance settings” option to initialize a communications interface to an electronic balance for sieve weights (step 416).

The computer 104 can be a handheld computer executing software stored in an excutable format such as a prc file. The software allows the handheld computer to track Daily Field Journals, such as:
Work Progress of Unit Bid Items and Contract Deliverables
Manpower Utilization
Equipment Utilization
General Information including weather, temperature, remarks, and inspector's name.

The software also tracks an Inspection Checklist, such as:
Generation of Punch list items
Tracking of Punch list items
Facility Inventory
Facility Repairs & Cost Estimates

The software also keeps Project Documentation and captures, among others:
Project Specifications
Industry Specifications
Drawing Logs

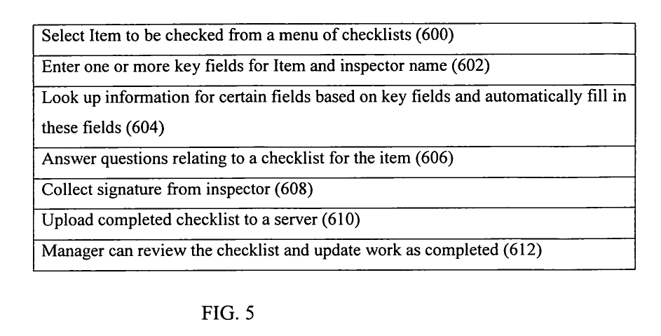

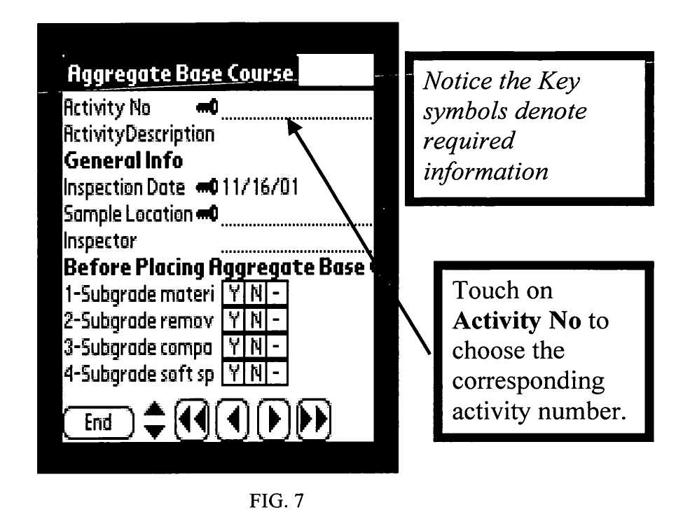

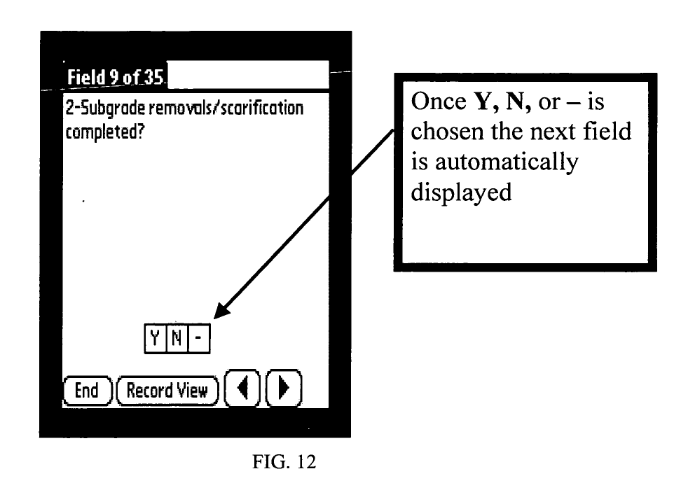

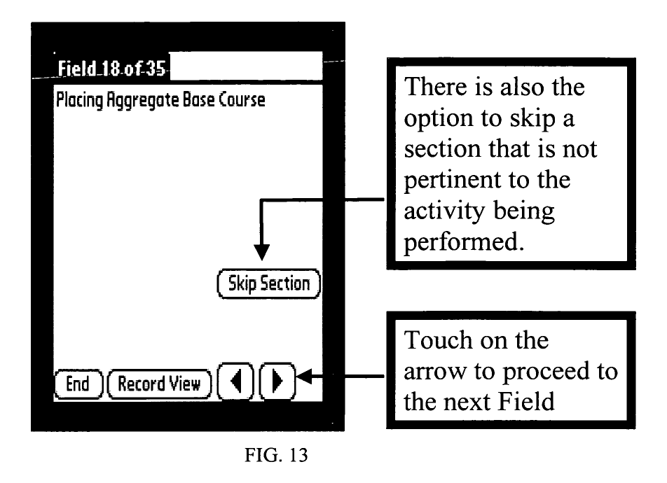

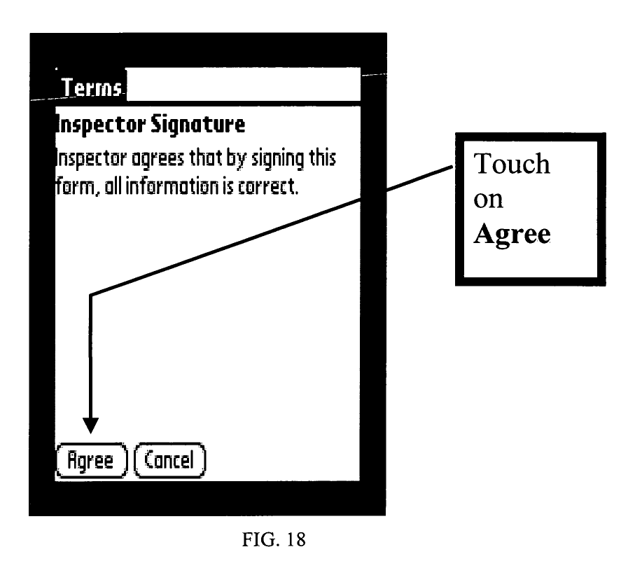

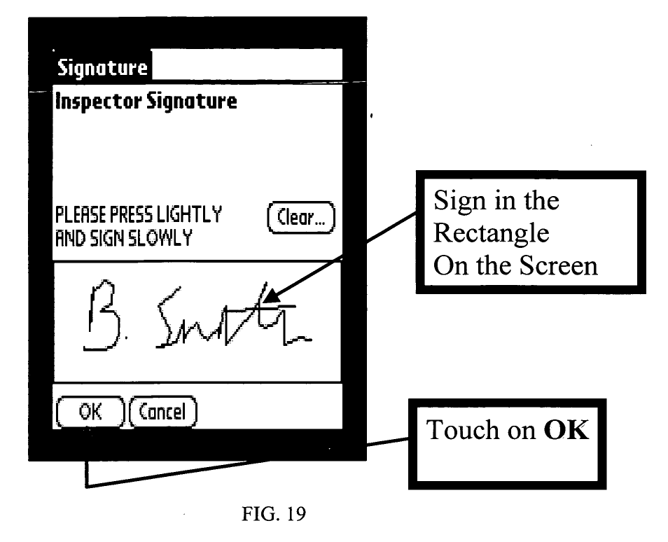

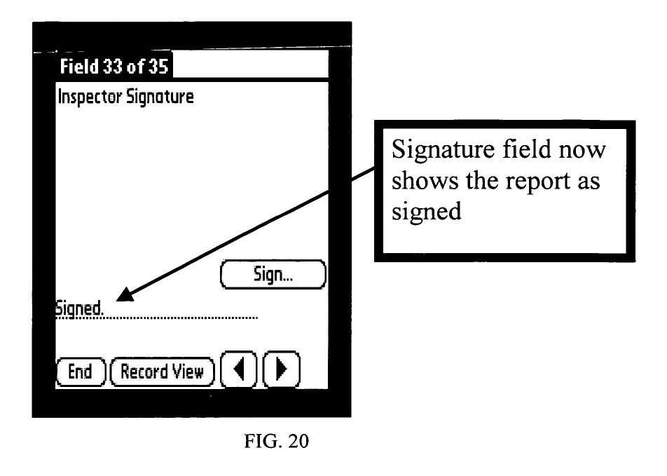

In collecting data in the field and uploading the data to the computer of FIG. 1, a user collects work in progress data. The information collected includes project/contract identification, inspector identification, item number, location, and one or more description of activities. Various exemplary screens on a handheld computer are shown as FIGS. 5-22. The user collects labor related cost. The information collected includes labor type, quantity and hours. Next, the process collects equipment being used for the project. The information collected includes equipment type, quantity, hours in use and stand-by hours. Next, the process collects additional submittal information. The information collected includes weather condition, comments, and the name of the inspector, among others. The process then sends the collected information to the system of FIG. 1. This can be done wirelessly using a wireless handheld unit such as the Palm VII, available from Palm Computing. Alternatively, the information can be transmitted using a modem or using an external computer with a suitable hot-sync cradle. In the later case, the handheld unit is synchronized with the external computer and, upon concluding the synchronization, the external computer opens a connection with the server of FIG. 1 and transmits the collected data from the handheld unit. The collected information is then imported to the database of FIG. 1, and appropriate data import operations and report generation operations can be done. The process then exits.

After collecting data, the handheld computer is placed in a hot sync cradle or aligned with an infrared port on a host computer for data transfer. The user, or inspector, activates a data receiving software on a workstation or a laptop. The user selects an icon to initiate data uploads and downloads to the handheld computer. The user will select the project to be updated or refreshed before selecting the icon. Only changed project information will be uploaded. The downloading of project information is performed the same way, a project is selected and selection of the icon initiates the file transfer. The file transfer results in the project information stored in a database to be converted to a handheld format such as a “pdb format”. The “pdb format” will result in an individual project table to be generated for each project on the handheld computer. Updates to the table are done in the same manner as described above.

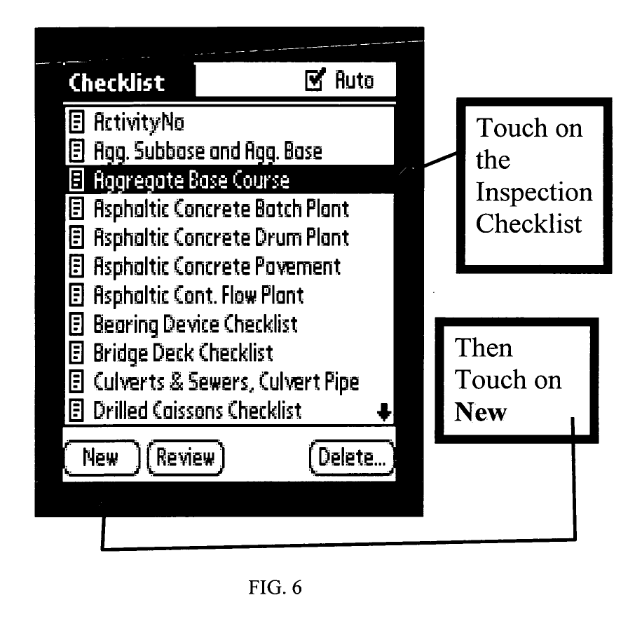

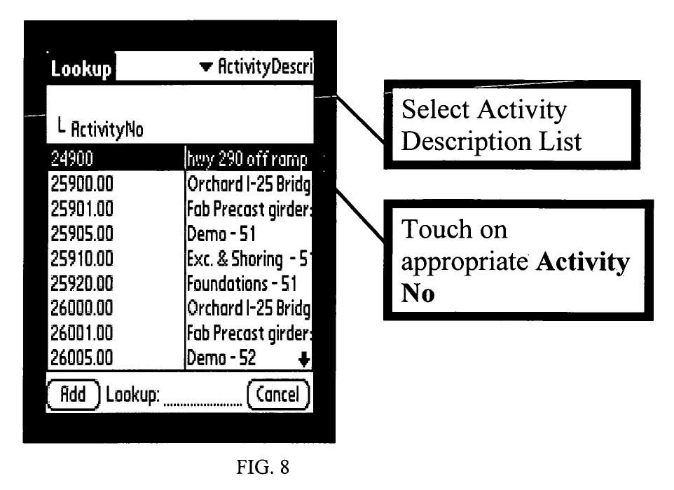

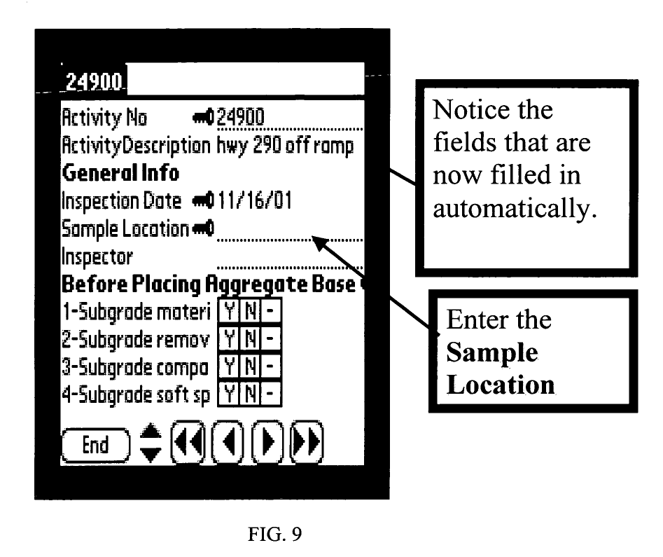

FIG. 5 shows an exemplary process to automatically handle checklists for tasks being monitored by the system. In this embodiment, the process runs on the handheld. First, a user through the process selects a particular workgroup or item to be checked from a menu of checklists (600). One embodiment of the item selection is shown in FIG. 6. Next, the user enters one or more key fields for the item (602). In this embodiment, the key fields are shown with a key icon. The user can select an activity description list as shown in FIG. 8. The user can also enter his or her inspector name. The process looks up information for certain fields based on key fields and the process automatically fills these fields (604), as shown in FIG. 9.

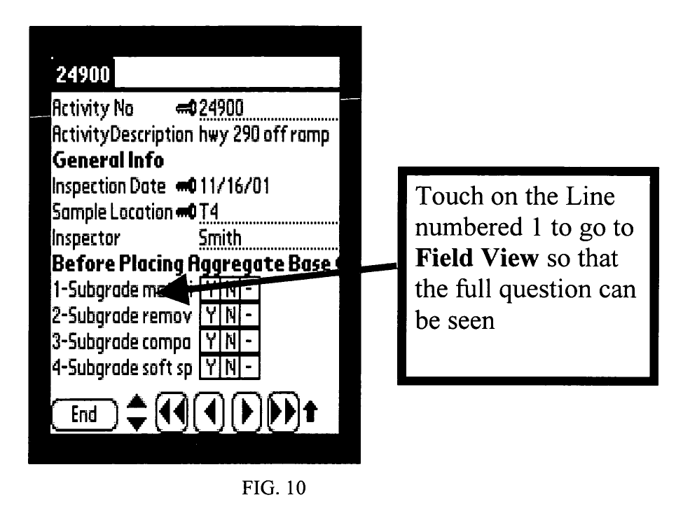

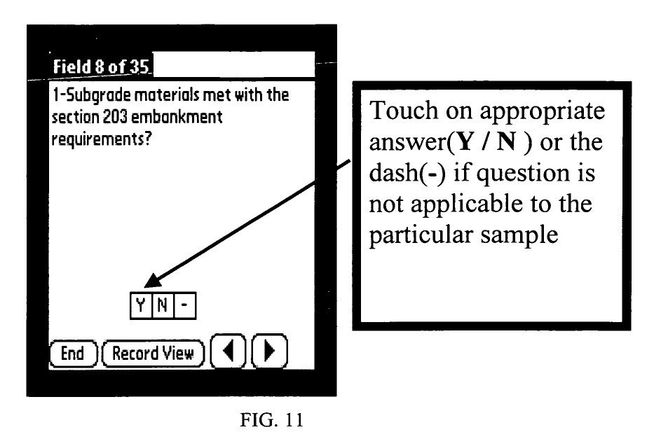

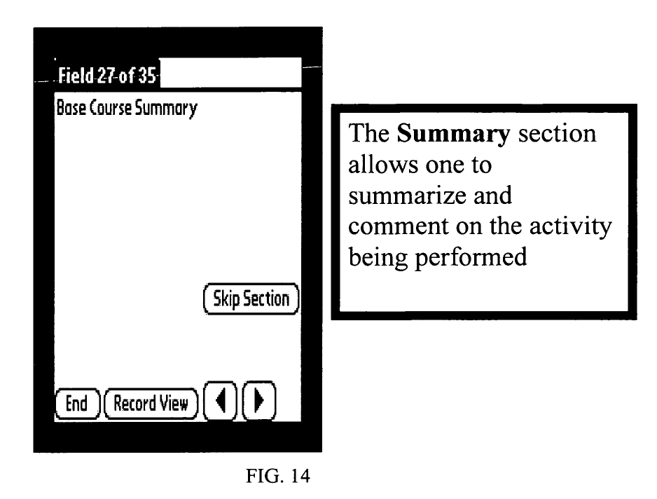

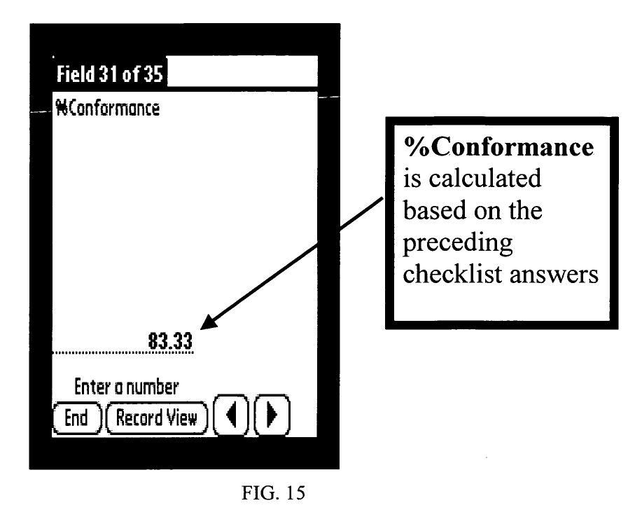

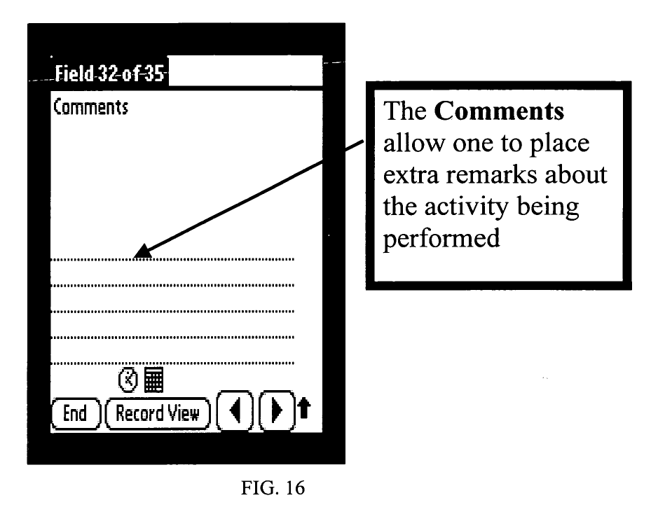

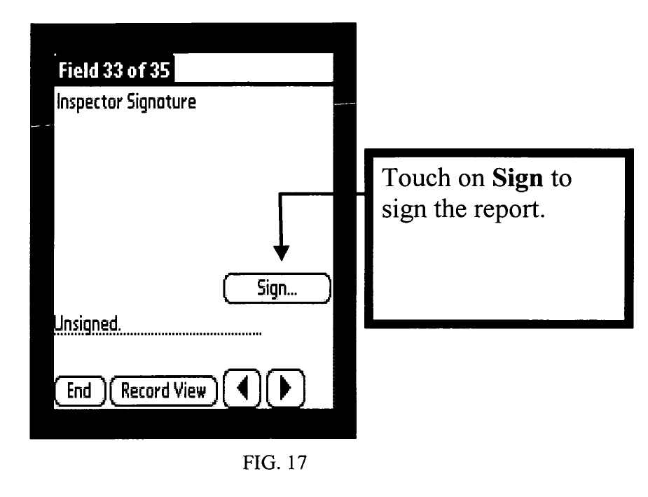

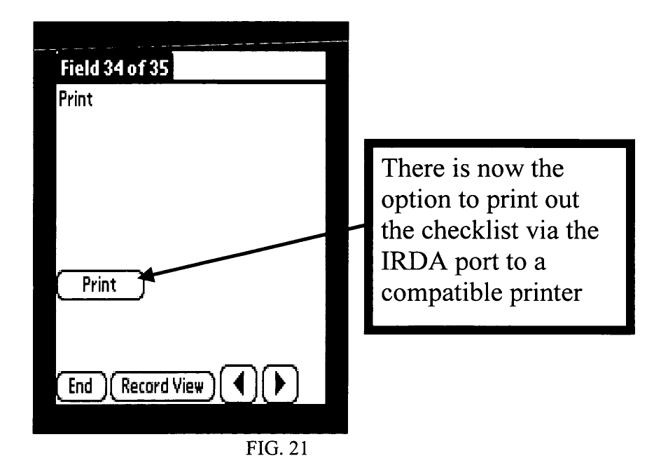

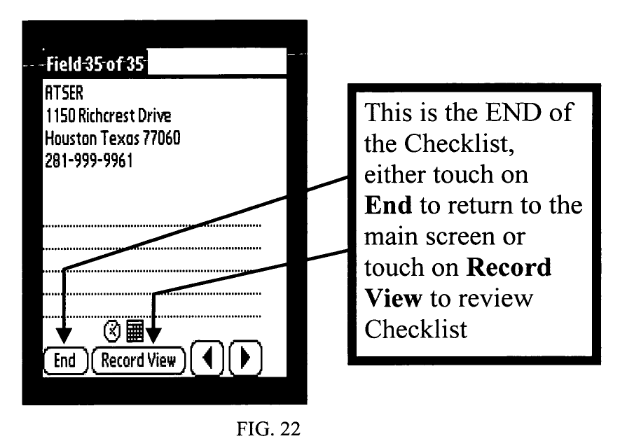

The process then requests the user to answer questions relating to a checklist for the item (606), as shown in FIG. 10. The user is guided through a sequence of questions, as shown in FIGS. 11-13. The process can also capture comments and/or summary from the user, as shown in FIG. 14 and 16. The process can also determine conformance to the checklist, as shown in FIG. 15. The process collects signature from inspector (608), as shown in FIGS. 17-20, and the user can print the result, as shown in FIG. 21. The user can return to the menu of checklists to select the next checklist item, as shown in FIG. 22.

Upload completed checklist to a server (610), where a manager can review the checklist and update work as completed (612).

In one embodiment, the checklist system takes existing construction specifications and construction method procedures and formulates questions or queries for presentation as a handheld computer checklist. These checklists reflect the scope of the completeness checklists generated during the design review of the final design documents. For example, the construction checklists reflect the workmanship and material requirements consolidated from the Construction Drawings, Completed Project Manual, Estimate of Construction Cost, Geotechnical Report, Final Engineering Design Report, Configuration Item Deliverables, and other related contract documents. The consolidation of this information into checklist questions format allows an inspector to verify compliance with these multiple final design documents into a punch list item format. The inspection checklists can in turn include one or more of the following punch list items: Aggregate Base Course, Asphaltic Concrete Batch Plant, Portland Cement Concrete Pavement, Asphaltic Concrete Pavement, Bases, Bridge Deck, Excavation and Embankment, Hot Bituminous Pavement (HBP) Placement, Pavement Markings, Portland Cement Concrete Pavement, Drilled Caissons, Placing Curing Concrete, Traffic Signals, and other project related deliverable items. The screen-shots shown in the above figures are examples of the Inspector checklists and demonstrate how the checklists are categorized by material type, construction activity, or deliverable item.

The checklist includes header information for electronic filing and easy retrieval of information into a database upon Hot-Syncing of the handheld computer. The header information includes: Project name, Inspector Name, Location, Date, Construction Activity, Material Description, Checklist Audit number, Checklist Type Form number, and other pertinent project information. The structure of the checklist questions includes: question number, question category, inspection question, and compliance/non-compliance checkbox, not-applicable checkbox response, and remarks fields. Also, included on the checklist form is the ability to capture electronic signature of photographs as objective evidence of the actual field site conditions. A compliance level is determined based upon the following exemplary determination:
% Compliance=# of Non-Conformance responses/Sum Total of (# of Conformance responses+Non-Conformance responses)

The checklist system maintains one or more days of checklist information on the handheld computer for the Inspector to refer back to or continue the inspection process until the percentage conformance level or compliance with the final design documents is achieved. The Inspector's hot-synced report is electronically transferred to the database and the project managers are prompted to review and approve new inspection checklist reports. Also, the system allow for the creation of new checklists and the insertion of new checklist questions as new design documents are introduced and updated or as specifications and construction procedures are refined.

Although an exemplary implementation has been shown for providing a checklist for construction applications, the system is expandable to other industries. Although the invention has been described with reference to specific embodiments, this description is not to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A construction management checklist system, comprising:
means for selecting an item to be checked from a menu of checklists;
means for entering one or more key fields for Item and inspector name;
means for locating information for certain fields based on key fields and automatically filling the fields;
means for displaying a sequence of questions and collecting answers relating to a checklist for the item;
means for capturing a signature from an inspector; and
means for uploading the checklist information to a server.

2. The system of claim 1, wherein the handheld computer collects work in progress data.

3. The system of claim 1, wherein the handheld computer collects project and contract identification, inspector identification, item number, location, and one or more description of activities.

4. The system of claim 1, wherein the checklist collects workmanship and material requirement.

5. The system of claim 1, wherein the checklist collects information from one of:
Construction Drawings, Completed Project Manual, Estimate of Construction Cost, Geotechnical Report, Final Engineering Design Report, Configuration Item Deliverables, contract documents.

6. The system of claim 1, wherein the checklist allows an inspector to verify compliance with one or more design documents into a punch list item format.

7. The system of claim 1, wherein the checklist comprises one or more punch list items: Aggregate Base Course, Asphaltic Concrete Batch Plant, Portland Cement Concrete Pavement, Asphaltic Concrete Pavement, Bases, Bridge Deck, Excavation and Embankment, Hot Bituminous Pavement (HBP) Placement, Pavement Markings, Portland Cement Concrete Pavement, Drilled Caissons, Placing Curing Concrete, Traffic Signals, project related deliverable items.

8. The system of claim 1, wherein the checklists are categorized by material type, construction activity, or deliverable item

9. The system of claim 1, wherein the handheld computer sends collected information to a server.

10. The system of claim 9, wherein the collected information wirelessly using a wireless handheld unit.

11. The system of claim 9, further comprising a modem coupled to the handheld computer, wherein the information can be transmitted using a modem.

12. The system of claim 9, further comprising a hot-sync cradle coupleable to the handheld computer, the cradle hot-syncing the collected information for transmission to a server.

13. A method for managing a construction project, comprising:
collecting construction data from the field and checking field work with a checklist using a handheld computer, including
selecting an item to be checked from a menu of checklists;
entering one or more key fields for Item and inspector name;
locating information for certain fields based on key fields and automatically filling the fields;
displaying a sequence of questions and collecting answers relating to a checklist for the item;
capturing a signature from an inspector; and
uploading the checklist information to a server;
tracking budgetary information using a planning system;
performing site engineering assessment using a design system; and
tracking material consumption and progress for each project using a construction system, the construction system adapted to receive data collected from the handheld computer.

14. The method of claim 13, comprising collecting workmanship and material requirement.

15. The method of claim 13, comprising collecting information from one of:
Construction Drawings, Completed Project Manual, Estimate of Construction Cost, Geotechnical Report, Final Engineering Design Report, Configuration Item Deliverables, contract documents.

16. The method of claim 13, comprising verifying compliance with one or more design documents into a punch list item format.

17. The method of claim 13, comprising collecting one or more punch list items:
Aggregate Base Course, Asphaltic Concrete Batch Plant, Portland Cement Concrete Pavement, Asphaltic Concrete Pavement, Bases, Bridge Deck, Excavation and Embankment, Hot Bituminous Pavement (HBP) Placement, Pavement Markings, Portland Cement Concrete Pavement, Drilled Caissons, Placing Curing Concrete, Traffic Signals, project related deliverable items.

18. The method of claim 13, wherein the checklists are categorized by material type, construction activity, or deliverable item

19. The method of claim 13, comprising hot-syncing the collected information from the handheld computer for transmission to a server.

20. The method of claim 13, further comprising sending collected information to a server over land-line or wireless medium.
